(19) United States
(12) Patent Application Publication
(10) Pub. No.: US 2023/0224960 A1
(43) Pub. Date: Jul. 13, 2023

(54) TECHNIQUES FOR ADAPTING RESOURCE SENSING IN SIDELINK COMMUNICATIONS SYSTEM

(71) Applicant: QUALCOMM INCORPORATED, San Diego, CA (US)

(72) Inventors: Gabi SARKIS, San Diego, CA (US); Stelios STEFANATOS, San Diego, CA (US); Shailesh PATIL, San Diego, CA (US); Tien Viet NGUYEN, Bridgewater, NJ (US); Bridgewater WU, San Diego, CA (US); Wanshi CHEN, San Diego, CA (US)

(21) Appl. No.: 18/000,920

(22) PCT Filed: Jul. 23, 2021
(86) PCT No.: PCT/US2021/042976

§ 371 Date: Dec. 6, 2022

(30) Foreign Application Priority Data
Jul. 27, 2020 (GR) 20200100444

(51) Int. Cl. H04W 74/08

(52) U.S. Cl. CPC H04W 74/0808; H04W 92/18

(57) ABSTRACT

Techniques for wireless communications are described. A communication device, such as a user equipment (UE) may determine a resource usage level in a wireless communications system. Additionally or alternatively, the UE may determine a transmission property associated with sidelink communication at the UE. The UE may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. In some examples, the UE may identify a set of resources used for the sidelink communication at the UE based on the adjusted sensing mode or the adjusted sensing parameter, or a combination thereof. The UE may perform the sidelink communication based on the sensing mode or the sensing parameter, or a combination thereof.

### CROSS REFERENCES

The present Application is a 371 national stage filing of International PCT Application No. PCT/US2021/042976 by SARKIS et al. entitled “TECHNIQUES FOR ADAPTING RESOURCE SENSING IN SIDELINK COMMUNICATIONS SYSTEM,” filed Jul. 23, 2021; and claims priority to Greek Patent Application No. 20200100444 by SARKIS et al. entitled “TECHNIQUES FOR ADAPTING RESOURCE SENSING IN SIDELINK COMMUNICATIONS SYSTEM,” filed Jul. 27, 2020, each of which is assigned to the assignee hereof, and each of which is expressly incorporated by reference in its entirety herein.

### FIELD OF DISCLOSURE

The present disclosure, for example, relates to sidelink communications, more particularly to techniques for adapting resource sensing in sidelink communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). Some wireless communications systems may support sidelink communications, for example, vehicle-based communications, also referred to as vehicle-to-everything (V2X) networks, vehicle-to-vehicle (V2V) networks, or cellular V2X (C-V2X) networks. Vehicle-based communication networks may provide always-on telematics where UEs (e.g., vehicle UEs (v-UEs)) communicate directly to the network (e.g., via vehicle-to-network (V2N) communications), to pedestrian UEs (e.g., via vehicle-to-pedestrians (V2P) communications), to infrastructure devices (vehicle-to-infrastructure (V2I) communications), and to other v-UEs (e.g., via the network or directly via V2V communications).

### SUMMARY

Various aspects of the described techniques relate to configuring a communication device, which may be a UE to support techniques for adapting a sensing procedure for sensing resources in a sidelink communications system. The UE may be configured to adapt the sensing procedure based on a resource usage level in the sidelink communications system, or a sidelink transmission property, or both. As described herein adapting the sensing procedure may include switching a sensing mode (e.g., a full sensing mode, a partial sensing mode, or a random resource-selection sensing mode) or a sensing parameter (e.g., a sensing window), or both. By adapting the sensing procedure, the UE may experience power saving. The described techniques may, as a result, also include features for improvements to sensing operations and, in some examples, may promote high reliability and low latency sidelink communications, among other benefits.

A method of sidelink communication at a UE in a wireless communications system is described. The method may include determining a resource usage level in the wireless communications system or a transmission property associated with the sidelink communication at the UE, or a combination thereof, adjusting, based on the determined resource usage level in the wireless communications system or the determined transmission property associated with the sidelink communication at the UE, or a combination thereof, a sensing mode of a sensing procedure or a sensing parameter of the sensing procedure, or a combination thereof, identifying a set of resources used for the sidelink communication at the UE based on the adjusted sensing mode or the adjusted sensing parameter, or a combination thereof, and performing the sidelink communication based on the sensing mode or the sensing parameter, or a combination thereof.

An apparatus for sidelink communication in a wireless communications system is described. The apparatus may include a processor, memory coupled with the processor, and instructions stored in the memory. The instructions may be executable by the processor to cause the apparatus to determine a resource usage level in the wireless communications system or a transmission property associated with the sidelink communication at the apparatus, or a combination thereof, adjust, based on the determined resource usage level in the wireless communications system or the determined transmission property associated with the sidelink communication at the apparatus, or a combination thereof, a sensing mode of a sensing procedure or a sensing parameter of the sensing procedure, or a combination thereof, identify a set of resources used for the sidelink communication at the apparatus based on the adjusted sensing mode or the adjusted sensing parameter, or a combination thereof, and perform the sidelink communication based on the sensing mode or the sensing parameter, or a combination thereof.

Another apparatus for sidelink communication in a wireless communications system is described. The apparatus may include means for determining a resource usage level in the wireless communications system or a transmission property associated with the sidelink communication at the apparatus, or a combination thereof, adjusting, based on the determined resource usage level in the wireless communications system or the determined transmission property associated with the sidelink communication at the apparatus, or a combination thereof, a sensing mode of a sensing procedure or a sensing parameter of the sensing procedure, or a combination thereof, identifying a set of resources used for the sidelink communication at the apparatus based on the adjusted sensing mode or the adjusted sensing parameter, or a combination thereof, and performing the sidelink communication based on the sensing mode or the sensing parameter, or a combination thereof.

A non-transitory computer-readable medium storing code for sidelink communication at a UE in a wireless communications system is described. The code may include instructions executable by a processor to determine a resource usage level in the wireless communications system or a transmission property associated with the sidelink communication at the UE, or a combination thereof, adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof, identify a set of resources used for the sidelink communication at the UE based on the adjusted sensing mode or the adjusted sensing parameter, or a combination thereof, and perform the sidelink communication based on the sensing mode or the sensing parameter, or a combination thereof.

In some examples of the method, apparatuses, and non-transitory computer-readable medium described herein, the sensing mode includes a full sensing mode, a partial sensing mode, or a random resource-selection mode.

In some examples of the method, apparatuses, and non-transitory computer-readable medium described herein, adjusting the sensing mode of the sensing procedure may include operations, features, means, or instructions for switching to the full sensing mode from the partial sensing mode or the random resource-selection mode based on the determined resource usage level in the wireless communications system satisfying a threshold, where identifying the set of resources used for the sidelink communication may be based on switching to the full sensing mode.

In some examples of the method, apparatuses, and non-transitory computer-readable medium described herein, adjusting the sensing mode of the sensing procedure may include operations, features, means, or instructions for switching to the random resource-selection mode from the full sensing mode or the partial sensing mode based on the determined resource usage level in the wireless communications system satisfying a threshold, where identifying the set of resources used for the sidelink communication may be based on switching to the random resource-selection mode.

In some examples of the method, apparatuses, and non-transitory computer-readable medium described herein, adjusting the sensing mode of the sensing procedure may include operations, features, means, or instructions for switching to the full sensing mode from the partial sensing mode or the random resource-selection mode based on a frequency resource allocation satisfying a threshold, where identifying the set of resources used for the sidelink communication may be based on switching to the full sensing mode.

In some examples of the method, apparatuses, and non-transitory computer-readable medium described herein, adjusting the sensing mode of the sensing procedure may include operations, features, means, or instructions for switching to the partial sensing mode or the random resource-selection mode from the full sensing mode based on a frequency resource allocation satisfying a threshold, where identifying the set of resources used for the sidelink communication may be based on switching to the random resource-selection mode.

In some examples of the method, apparatuses, and non-transitory computer-readable medium described herein, adjusting the sensing parameter of the sensing procedure may include operations, features, means, or instructions for adjusting a size of a sensing window based on the determined resource usage level in the wireless communications system or the determined transmission property associated with the sidelink communication at the UE, or a combination thereof, where identifying the set of resources used for the sidelink communication includes, and identifying the set of resources based on the adjusted size of the sensing window.

In some examples of the method, apparatuses, and non-transitory computer-readable medium described herein, adjusting the sensing parameter of the sensing procedure may include operations, features, means, or instructions for adjusting a number of slots to use for sensing the set of resources, the number of slots associated with a sensing window, based on the determined resource usage level in the wireless communications system or the determined transmission property associated with the sidelink communication at the UE, or a combination thereof, where identifying the set of resources used for the sidelink communication includes, and identifying the set of resources based on the adjusted number of slots to use for sensing the set of resources.

In some examples of the method, apparatuses, and non-transitory computer-readable medium described herein, determining the resource usage level may include operations, features, means, or instructions for determining a channel busy ratio associated with a sidelink channel in the wireless communications system.

In some examples of the method, apparatuses, and non-transitory computer-readable medium described herein, determining the resource usage level may include operations, features, means, or instructions for determining a channel occupancy ratio associated with a sidelink channel in the wireless communications system.

In some examples of the method, apparatuses, and non-transitory computer-readable medium described herein, determining the transmission property may include operations, features, means, or instructions for determining a modulation and coding scheme associated with the sidelink communication at the UE.

In some examples of the method, apparatuses, and non-transitory computer-readable medium described herein, determining the transmission property may include operations, features, means, or instructions for determining a transport block size associated with the sidelink communication at the UE.

In some examples of the method, apparatuses, and non-transitory computer-readable medium described herein, determining the transmission property may include operations, features, means, or instructions for determining a size of a frequency resource allocation associated with the sidelink communication at the UE.

In some examples of the method, apparatuses, and non-transitory computer-readable medium described herein, determining the transmission property may include operations, features, means, or instructions for determining a rate of the sidelink communication at the UE.

In some examples of the method, apparatuses, and non-transitory computer-readable medium described herein, determining the transmission property may include operations, features, means, or instructions for determining a transmission priority of the sidelink communication at the UE.

Some examples of the method, apparatuses, and non-transitory computer-readable medium described herein may further include operations, features, means, or instructions for identifying a sensing configuration per resource pool, determining an association between the sensing mode, the sensing parameter, the determined resource usage level in the wireless communications system, or the determined transmission property associated with the sidelink communication at the UE, or a combination thereof, based on the sensing configuration per resource pool, and determining to adjust the sensing mode of the sensing procedure or the sensing parameter of the sensing procedure, or a combination thereof, based on the determined association.

Some examples of the method, apparatuses, and non-transitory computer-readable medium described herein may further include operations, features, means, or instructions for receiving, from another UE, a message including an indication of the sensing configuration on one or more configured resources.

Some examples of the method, apparatuses, and non-transitory computer-readable medium described herein may further include operations, features, means, or instructions for receiving, from another UE, a message including an indication of the sensing configuration on one or more periodic reserved resources.

### BRIEF DESCRIPTION OF THE DRAWINGS

FIGS. 1 and 2 illustrate examples of wireless communications systems that support techniques for adapting resource sensing in sidelink communications system in accordance with various aspects of the present disclosure.

FIG. 3 illustrates an example of a sensing procedure that supports techniques for adapting resource sensing in sidelink communications system in accordance with various aspects of the present disclosure.

FIG. 4 illustrates an example of a process flow that supports techniques for adapting resource sensing in sidelink communications system in accordance with various aspects of the present disclosure.

FIGS. 5 and 6 show block diagrams of devices that support techniques for adapting resource sensing in sidelink communications system in accordance with various aspects of the present disclosure.

FIG. 7 shows a block diagram of a user equipment (UE) communications manager that supports techniques for adapting resource sensing in sidelink communications system in accordance with various aspects of the present disclosure.

FIG. 8 shows a diagram of a system including a device that supports techniques for adapting resource sensing in sidelink communications system in accordance with various aspects of the present disclosure.

FIGS. 9 through 13 show flowcharts illustrating methods that support techniques for adapting resource sensing in sidelink communications system in accordance with various aspects of the present disclosure.

### DETAILED DESCRIPTION

Some wireless communication systems may support sidelink communication. For example, a UE may communicate with other UEs via a sidelink channel. In some examples, the UE may perform a sensing procedure to reserve resources for sidelink communication with the other UEs. During the sensing procedure, the UE may receive and decode control signals from the others UEs within a resource sensing window and gain knowledge on which resources are available for transmissions or which resources are not available for transmission. The UE may be preconfigured with one or multiple sensing modes. The sensing modes may include a full sensing mode, a partial sensing mode, and random resource-selection sensing mode. The partial sensing mode and the random resource-selection sensing mode may be considered reduced sensing modes because instead of sensing all resources (e.g., slots) of the resource sensing window, the UE senses a portion of the resources within the resource sensing window.

In some cases, the UE may encounter different load situations which may benefit from different sensing modes. For example, a large system load may benefit from the full sensing mode, whereas a small system load may not benefit from the full sensing mode when compared to the partial sensing mode or the random resource-selection sensing mode. However, the UE may be unable to change the preconfigured sensing mode which may result in excess power consumption at the UE. Various aspects of the described techniques relate to configuring the UE to support techniques for adapting a sensing procedure for sensing resources in a sidelink communications system. For example, the UE may adapt the sensing procedure based on values associated with system utilization conditions or transmission properties.

The system utilization conditions values may include a channel occupancy ratio value or a channel busy ratio. The higher the channel occupancy ratio value or the channel busy value, the higher the channel congestion. Transmission property values may include a modulation and coding scheme value, a transport block size, a frequency allocation size, how frequently a transmission is made, or a priority of the transmission. The UE may determine a value associated with the system utilization conditions or the transmission properties, and may adapt the sensing procedure based on the value. By adapting the sensing procedure according to the system utilization conditions or the transmission properties, the UE may avoid situations of excess power consumption.

Aspects of the disclosure are initially described in the context of wireless communications systems. Aspects of the disclosure are further illustrated by and described with reference to apparatus diagrams, system diagrams, and flowcharts that relate to techniques for adapting resource sensing in sidelink communications system.

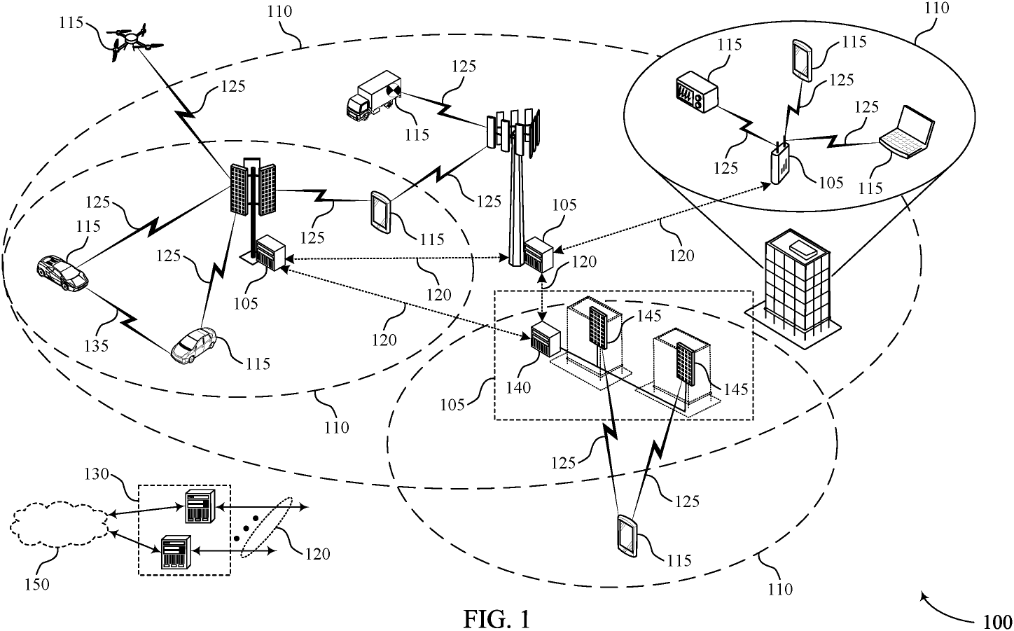

FIG. 1 illustrates an example of a wireless communications system 100 that supports techniques for adapting resource sensing in sidelink communications system in accordance with various aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode). A carrier may be associated with a bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may be of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the base stations 105 or the UEs 115 may be expressed in multiples of a basic time unit which may, for example, refer to a sampling period of Tₛ = 1/(Δƒₘₐₓ · N_{ƒ}) seconds, where Δƒₘₐₓ may represent the maximum supported subcarrier spacing, and N_{ƒ} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In the wireless communications system 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or radio frequency spectrum band of operation. A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) radio frequency spectrum bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, V2V communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using V2N communications, or with both.

In some examples, the UEs 115 may perform a sensing procedure to reserve resources for sidelink communication with the other UEs 115. During the sensing procedure, the UEs 115 may receive and decode control signals from the others UEs 115 within a resource sensing window and gain knowledge on which resources are available for transmissions or which resources are not available for transmission. The UEs 115 may be preconfigured with one or multiple sensing modes. The sensing modes may include a full sensing mode, a partial sensing mode, and a random resource-selection sensing mode. The partial sensing mode and the random resource-selection sensing mode may be considered reduced sensing modes because instead of sensing all resources (e.g., slots) of the resource sensing window, the UEs 115 senses a portion of the resources within the resource sensing window.

In some cases, the UEs 115 may encounter different load situations which may benefit from different sensing modes. For example, a large system load may benefit from the full sensing mode, whereas a small system load may not benefit from the full sensing mode when compared to the partial sensing mode or the random resource-selection sensing mode. However, the UEs 115 may be unable to change the preconfigured sensing mode which may result in excess power consumption at the UEs 115. Various aspects of the described techniques relate to configuring the UEs 115 to support techniques for adapting a sensing procedure for sensing resources in a sidelink communications system. For example, the UEs 115 may adapt the sensing procedure based on values associated with system utilization conditions or transmission properties.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more radio frequency spectrum bands, in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using radio frequency spectrum bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

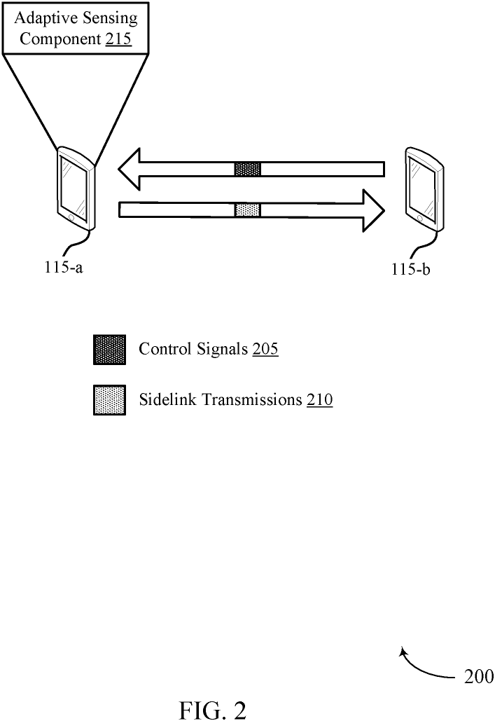

FIG. 2 illustrates an example of a wireless communications system 200 that supports techniques for adapting resource sensing in sidelink communications system in accordance with various aspects of the present disclosure. The wireless communications system 200 may implement aspects of the wireless communications system 100. For example, the wireless communications system 200 may include a UE 115-a and a UE 115-b, which may be examples of a UE 115 as described with reference to FIG. 1. The wireless communications system 200 may support multiple radio access technologies including 4G systems such as LTE systems, LTE-A systems, or LTE-A Pro systems, and 5G systems which may be referred to as NR systems.

In the example of FIG. 2, the UE 115-a and the UE 115-b may support sidelink communications. For example, the UE 115-a may communicate with the UE 115-b over a sidelink channel. The sidelink communications may be referred to as D2D communications, V2V communications, V2X communications, and the like. The UE 115-a and the UE 115-b may be configured with multiple antennas, which may be used to employ techniques such as transmit diversity, receive diversity, or beamformed communications. The antennas of the UE 115-a and the UE 115-b may be located within one or more respective antenna arrays or antenna panels, which may support beamformed sidelink operations. The UE 115-a and the UE 115-b may have an antenna array with a number of rows and columns of antenna ports that the UE 115-a and the UE 115-b may use to support beamforming of sidelink communications.

In some examples, the UE 115-a may undergo a sensing procedure to reserve resources for communications with the UE 115-b, for example, to transmit or receive sidelink transmissions 210 to or from the UE 115-b. In order to transmit the sidelink transmissions 210, the UE 115-a may perform sensing, reservation, and transmission. During the sensing procedure, the UE 115-a may receive one or more control signals 205 from other UEs 115. For example, the UE 115-a may receive control signals 205 from the UE 115-b. The UE 115-a may decode the control signals 205 from other UEs 115, which may allow the UE 115-a to gain knowledge on which resources are already reserved by the UEs 115 and which resources are available for communication with the UE 115-b.

The UE 115-a may perform decoding of control signals 205 during a sensing window (e.g., amount of time the UE 115-a will sense). The sensing window size (e.g., time duration) may be configured to be 100 milliseconds (ms) or 1100 ms. Once the UE 115-a completes the sensing procedure, the UE 115-a may detect a resource selection trigger, reserve available resources within a resource selection window, and transmit the sidelink transmissions 210 to the UE 115-b via the reserved resources. In some examples, the resources may be reserved periodically or aperiodically.

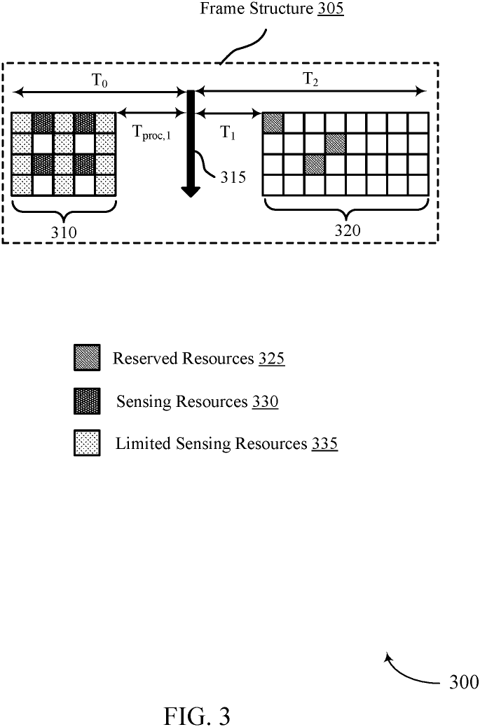

In some examples, the UE 115-a may be pre-configured with a sensing procedure. For example, the UE 115-a may be preconfigured with one or multiple sensing modes, such as a full sensing mode (e.g., all slots in a sensing window are sensed), a partial sensing mode (e.g., a subset of slots in the sensing window are sensed), or a random resource-selection sensing mode (e.g., random slots are sensed, also known as random sensing). The partial sensing mode and the random resource-selection sensing mode may be referred to as reduced power sensing modes. That is, the UE 115-a may use one sensing mode for all communications with the UE 115-b. For example, the UE 115-a may be preconfigured with a full sensing mode and reserve available resources for communication with the UE 115-b using the full sensing mode. However, the full sensing mode may be computationally expensive, and some situations may not call for full sensing. For example, if the system load is low, the partial sensing mode or the random resource-selection sensing mode may yield the same or similar results as the full sensing mode. Thus, the power consumption resulting from the full sensing mode may be unwarranted. In addition to the partial sensing mode and the random resource-selection sensing mode, the UE 115-a may switch sensing parameters of a sensing procedure to save on power consumption. For example, the UE 115-a may change a size of a sensing window size, a sensing duty cycle, a location of a resource selection trigger, or a combination thereof, as described in FIG. 3.

The UE 115-a may adapt the sensing procedure based on current system resource utilization conditions (also known as resource usage levels) or transmission properties. For example, the UE 115-a may be configured with an adaptive sensing component 215. The adaptive sensing component 215 may be used to modify the sensing procedure based on system resource utilization conditions or transmission properties, or both. Some examples of resource utilization conditions may be a channel busy ratio value or a channel occupancy ratio value. The channel busy ratio value may be described as a fraction of subframes for which received signal strength indicator (RSSI) exceeds a predetermined threshold. The channel occupancy ratio value may be described as a total number of sub-channels used by the UE 115-a or the UE 115-b, or both, for its transmissions divided by the total number of configured sub-channels over a measurement period of 1000 ms. Both the channel busy ratio value and the channel occupancy ratio value may be used to evaluate channel congestion.

Some examples of transmission properties include a modulation and coding scheme value, transport block size, a frequency allocation size, how frequently a transmission is made, or a priority of the transmission. Based on the values of the system resource utilization conditions or transmission properties, the UE 115-a, using the adaptive sensing component 215, may modify the sensing procedure. For example, the UE 115-a may determine that the channel busy ratio value is low (e.g., below a threshold) and adapt the sensing procedure to reflect a reduced sensing procedure (e.g., a partial sensing mode, a random resource-selection sensing mode, a reduced sensing-window size, or a reduced sensing duty cycle, or on-demand sensing). Additionally or alternatively, the UE 115-a may determine that the transport block size is small (e.g., below a threshold) and adapt the sensing procedure to reflect a reduced sensing procedure. Alternatively, the UE 115-a may determine the transport block size is large (e.g., above a threshold) and choose not to change the sensing procedure or implement the full sensing mode (e.g., sensing all slots in a frequency window). The reduced sensing procedure (e.g., operating in a partial sensing mode or a random resource-selection sensing mode) or sensing procedure parameters (e.g., a reduced window size) and their association with system resource utilization conditions or transmission properties (e.g., thresholds) may be preconfigured (e.g., for each resource pool) or indicated by other UEs 115 (e.g., roadside units (RSU)).

Accordingly, because the UE 115-a in the wireless communications system 200 is configured to adjust a sensing procedure (e.g., a sensing mode of the sensing procedure or a sensing parameter of the sensing procedure, or both), the UE 115-a may be able to experience power saving for sensing operations in the wireless communications system 200. The described techniques may, as a result, include features for improvements to sensing operations and, in some examples, may promote high reliability and low latency sidelink communications, among other benefits.

FIG. 3 illustrates an example of a sensing procedure 300 that supports techniques for adapting resource sensing in sidelink communications system in accordance with various aspects of the present disclosure. In some examples, the sensing procedure 300 may implement aspects of a wireless communications system 100 and a wireless communications system 200, as described in FIGS. 1 and 2. The sensing procedure 300 may be based on a configuration by a base station 105, and implemented by a UE 115 to promote power saving for the UE 115 by supporting techniques for adapting resource sensing in sidelink communications system. In some examples, the sensing procedure 300 may also be based on a configuration by the base station 105 and implemented by the UE 115 to achieve higher reliability for sensing operations by adapting resource sensing in sidelink communications system, among other benefits.

The sensing procedure 300 may include a frame structure 305, which may include a sensing window 310, a resource selection trigger 315, and a resource selection window 320. With reference to FIG. 2, the UE 115-a may monitor a control channel (e.g., a sidelink control channel) to receive and decode control signals during the sensing window 310. Upon receiving the resource selection trigger 315 (e.g., a data packet received T_{proc,1} after the resource selection window 320 and T₁ before the resource selection window 320), the UE 115-a may reserve available resources within the resource selection window 320 for sidelink communication with the UE 115-b. In some examples, the sensing window 310 may be configured to span 100 ms or 1100 ms (e.g., T₀ = 100 ms or 1100 ms), which may correspond to 32 slots in the resource selection window 320 for aperiodic reservations.

The UE 115-a may reserve resources in a first time slot and in up to two future slots of the resource selection window 320. The resources may be reserved in units of subchannels within the resource selection window 320 and may be periodic or aperiodic in a time domain. For example, reserved resources 325 may be repeated in the resource selection window 320 based on a configurable period (e.g., between 0 and 1000 ms). In some examples, the UE 115-b may transmit, and the UE 115-a may receive, reservation information (e.g., indication of reserved resources 325 or period for periodic reservation) in sidelink control information (SCI). In some examples, the UE 115-a may not receive the resource selection trigger 315. In such situations, the UE 115-a may undergo the sensing procedure 300 without the reservation of resources. Because the UE 115-a may not know when a trigger may occur, the UE 115-a may remain power on to sense for resources (e.g., full sensing), which may be computationally expensive and cause excess power consumption at the UE 115-a. As a result, adaptive reduced sensing procedures may be implemented.

With reference to FIG. 2, the UE 115-a may adjust the sensing procedure 300 based on values associated with resource utilization conditions or transmission properties. For example, the UE 115-a adjust the sensing procedure 300 by switching a sensing mode, for example, a full sensing mode, a partial sensing mode, and a random resource-selection sensing mode. In the full sensing mode, the UE 115-a may sense all slots in the sensing window 310. In the partial sensing mode, the UE 115-a may sense a subset of slots in the sensing window 310. In the random resource selection mode, the UE 115-a may sense random slots in the sensing window 310. The partial sensing mode and the random resource selection mode may be examples of reduced sensing because these modes reduce power consumption at the UE 115-a when compared to other sensing modes (e.g., full sensing mode).

The UE 115-a may determine values associated with resource utilization conditions, for example, such as a channel busy ratio or a channel occupancy ratio, and select a sensing mode based on these values. For example, if the channel busy ratio value or the channel occupancy ratio value is low (e.g., below a threshold), the UE 115-a may switch to the partial sensing mode or the random resource-selection sensing mode to reduce power consumption compared to the full sensing mode. Alternatively, if the channel busy ratio value or the channel occupancy ratio value is high (e.g., above a threshold), the UE 115-a may switch to the full sensing mode. A high channel busy ratio value or a channel occupancy ratio value may indicate a high level of congestion in a sidelink channel (e.g., high system load). The higher the congestion, the less likely the UE 115-a will identify available resources without operating in the full sensing mode. As such, the higher power consumption experienced when operating in the full sensing mode may be warranted in situations of increased congestion.

In some examples, the UE 115-a may determine values associated with transmission properties such as a modulation and coding scheme value, a transport block size, a frequency allocation size, a transmission priority, or a frequency of transmissions, or any combination thereof, and select a sensing mode based on these values. For example, if the value for frequency allocation size is large (e.g., above a threshold), the UE 115-a may select full sensing. Alternatively, if the value associated with the frequency allocation size is small (e.g., below a threshold), the UE 115-a may switch to the partial sensing mode or the random resource selection mode. The sensing mode (e.g., the full sensing mode, the partial sensing mode, and the random resource-selection sensing mode) and their relationships to the resource utilization condition values or the transmission properties values may be configured or indicated to the UE 115-a by the UE 115-b on pre-configured resources or periodically reserved resources.

In some examples, the UE 115-a may switch a sensing mode or a sensing parameter associated with the sensing procedure 300 based on values associated with the resource utilization conditions or the transmission properties. The sensing parameters that may be changed include the sensing window 310, a sensing duty cycle, and the location of resource selection trigger 315. For example, if the UE 115-a determines a low channel busy ratio or a small transport block size (e.g., below a threshold), the UE 115-a may reduce the sensing window 310 to a time span of 50 ms (e.g., T₀ = 50 ms or < 32 slots). In such case, the UE 115-a may reserve resources from the resource selection window 320 including less than 32 slots. Additionally, the sensing window 310 may be further reduced to a subset of slots or resources. For example, the UE 115-a may identify sensing resources 330 or limited sensing resources 335.

In some examples, if the UE 115-a determines a low channel busy ratio or a small transport block size (e.g., below a threshold), the UE 115-a may reduce the sensing duty cycle. For example, the UE 115-a may adjust the sensing procedure 300 such that the resource selection window 320, for example, when the UE 115-a is operating in a first sensing mode of the sensing procedure 300 overlaps (e.g., partially or fully) with a resource sensing window when the UE 115-a is operating in a second sensing mode of the sensing procedure 300. That is, the UE 115-a performs sensing according to the second sensing mode during the resource selection window 320, which reduces the overall time between sensing sessions.

In some examples, if the UE 115-a determines a low channel busy ratio or a small transport block size (e.g., below a threshold), the UE 115-a may change a location of the resource selection trigger 315. For example, the resource selection trigger 315 may be received prior to sensing. In such example, the UE 115-a may perform sensing after a resource selection trigger is received. Other conditions that may initiate reduced sensing parameters may be a small channel occupancy ratio value, a small modulation and coding scheme value, a low frequency allocation size, a low priority transmission, etc. The sensing procedure parameters (e.g., the sensing window 310, sensing duty cycle, and the location of resource selection trigger 315) and their relationship to resource utilization condition values or transmission properties values may be configured (e.g., per resource pool) or indicated to the UE by other UEs on pre-configured resources or periodically reserved resources.

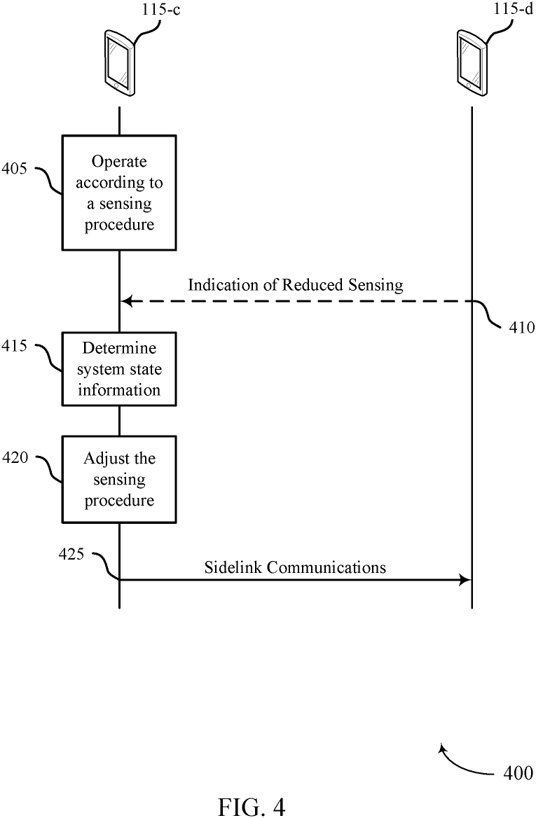

FIG. 4 illustrates an example of a process flow 400 that supports techniques for adapting resource sensing in sidelink communications system in accordance with various aspects of the present disclosure. The process flow 400 may implement aspects of a wireless communications system 100 and a wireless communications system 200 as described with reference to FIGS. 1 and 2, respectively. The process flow 400 may be based on a configuration by a base station 105, and implemented by a UE 115 (e.g., a UE 115-c or a UE 115-d, or both) to promote power saving for the UE 115 by supporting techniques for adapting resource sensing in sidelink communications system. The process flow 400 may be based on a configuration by the base station 105 and implemented by the UE 115 to achieve higher reliability for sensing operations by adapting resource sensing in sidelink communications system, among other benefits.

The UE 115-c and the UE 115-d may be examples of a UE 115, as described herein. In the following description of the process flow 400, the operations between the UE 115-c and the UE 115-d may be transmitted in a different order than the example order shown, or the operations performed by the UE 115-c and the UE 115-d may be performed in different orders or at different times. The operations illustrated in the process flow 400 may be performed by hardware (e.g., including circuitry, processing blocks, logic components, and other components), code (e.g., software or firmware) executed by a processor, or any combination thereof, of the UE 115-c and the UE 115-d. Some operations may also be omitted from the process flow 400, and other operations may be added to the process flow 400.

In the example of FIG. 4, the UE 115-c may be an example of a power sensitive UE (e.g., pedestrian wireless device or a battery operated wireless device). In order for the UE 115-c to communicate with other UEs 115, such as the UE 115-d, the UE 115-c may undergo a sensing procedure to locate available resources on which to communicate with the UE 115-d. In such examples, the UE 115-c may identify a value associated with system load and adapt the sensing procedure based on this value. For example, if the value associated with the system load is low (e.g., below a threshold), the UE 115-c may switch to a reduced sensing procedure which may reduce power consumption at the UE 115-c during occasions of decreased system load. The UE 115-c and the UE 115-d may implement one or more techniques described herein to adapt a sensing procedure.

At 405, the UE 115-c may operate according to a sensing procedure. For example, the UE 115-c may operate in a full sensing mode, a partial sensing mode, or a random resource-selection sensing mode, as described herein. For example, in the full sensing mode, the UE 115-c may sense all slots before reserving resources for sidelink communication with the UE 115-d. At 410, the UE 115-c may receive an indication for reduced sensing from the UE 115-d. The reduced sensing indication may include sensing modes (e.g., a full sensing procedure, a partial sensing procedure, or no-sensing), sensing parameters (e.g., a sensing window size, a number of slots to use for sensing resources, or a resource selection trigger location) and their relationship to system state information (e.g., system resource utilization values or transmission property values). Alternatively, the sensing mode or the sensing parameters and their relationship to the system state information may be pre-configured (e.g., per resource pool).

At 415, the UE 115-c may determine system state or system load information. For example, the UE 115-c may determine a value associated with system resource utilization or transmission properties, or a combination thereof. In some examples, the system resource utilization value may be a channel busy ratio value. In some other examples, the system resource utilization value may be a channel occupancy ratio value. The transmission property value may be a modulation and coding scheme value, a transport block size, a frequency allocation size, a frequency of a transmission, or a priority of a transmission, or any combination thereof.

At 420, the UE 115-c may adjust the sensing procedure (e.g., a sensing mode, a sensing parameter) based on the values associated with the system resource utilization or the transmission properties. For example, if the value for the channel busy ratio value, the channel occupancy ratio value, the transport block size, the modulation and coding scheme, the frequency allocation size, or the priority of a transmission, or a combination thereof, is low (e.g., below a threshold), the UE 115-c may switch from a full sensing mode to a reduced sensing mode (e.g., a partial sensing mode). At 425, the UE 115-c may transmit sidelink communications to the UE 115-d via a sidelink. The resource on which the UE 115-c communicates with the UE 115-d may be determined based on the sensing procedure determined at 420.

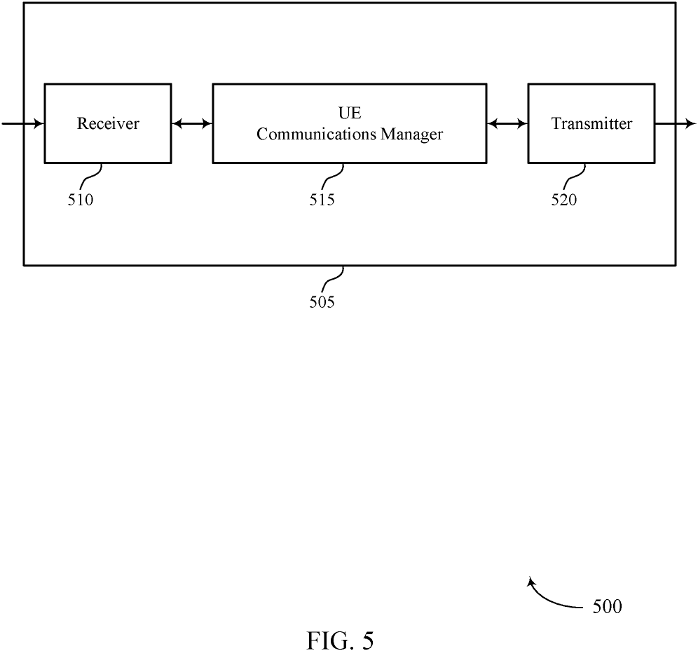

FIG. 5 shows a block diagram 500 of a device 505 that supports techniques for adapting resource sensing in sidelink communications system in accordance with various aspects of the present disclosure. The device 505 may be an example of aspects of a UE 115 as described herein. The device 505 may include a receiver 510, a UE communications manager 515, and a transmitter 520. The device 505 may also include a processor. Each of these components may be in communication with one another (e.g., via one or more buses).

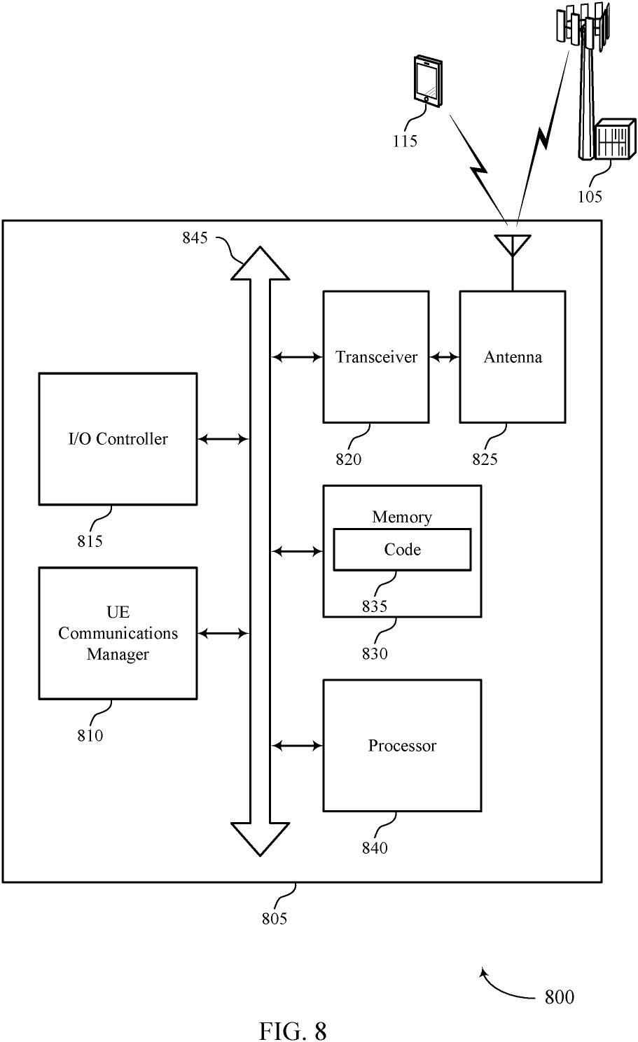

The receiver 510 may receive information such as packets, user data, or control information associated with various information channels (e.g., control channels, data channels, and information related to techniques for adapting resource sensing in sidelink communications system). Information may be passed on to other components of the device 505. The receiver 510 may be an example of aspects of the transceiver 820 described with reference to FIG. 8. The receiver 510 may utilize a single antenna or a set of antennas.

The UE communications manager 515 may determine a resource usage level in the wireless communications system or a transmission property associated with the sidelink communication at the UE, or a combination thereof. The UE communications manager 515 may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The UE communications manager 515 may identify a set of resources used for the sidelink communication at the UE based on the adjusted sensing mode or the adjusted sensing parameter, or a combination thereof, and perform the sidelink communication based on the sensing mode or the sensing parameter, or a combination thereof. The UE communications manager 515 may be an example of aspects of the UE communications manager 810 described herein.

The UE communications manager 515 may enable the device 505 to provide enhanced sensing based on adapting a sensing procedure. In some implementations, the UE communications manager 515 may enable the device 505 to determine a resource usage level of a wireless communications system, for example, based on a channel busy ratio or a channel occupancy ration. Additionally or alternatively, the UE communications manager 515 may enable the device 505 to determine a transmission property for sidelink communications by the device 505. Based on implementing these determinations, one or more processors of the device 505 (e.g., processor(s) controlling or incorporated with the UE communications manager 515) may adjust a sensing mode or a sensing parameter of the sensing procedure, and thereby reduce power consumption and promote high reliability sensing operations, among other benefits.

The UE communications manager 515, or its sub-components, may be implemented in hardware, code (e.g., software or firmware) executed by a processor, or any combination thereof. If implemented in code executed by a processor, the functions of the UE communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The UE communications manager 515, or its sub-components, may be physically located at various positions, including being distributed such that portions of functions are implemented at different physical locations by one or more physical components. In some examples, the UE communications manager 515, or its sub-components, may be a separate and distinct component in accordance with various aspects of the present disclosure. In some examples, the UE communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver component. For example, the transmitter 520 may be an example of aspects of the transceiver 820 described with reference to FIG. 8. The transmitter 520 may utilize a single antenna or a set of antennas.

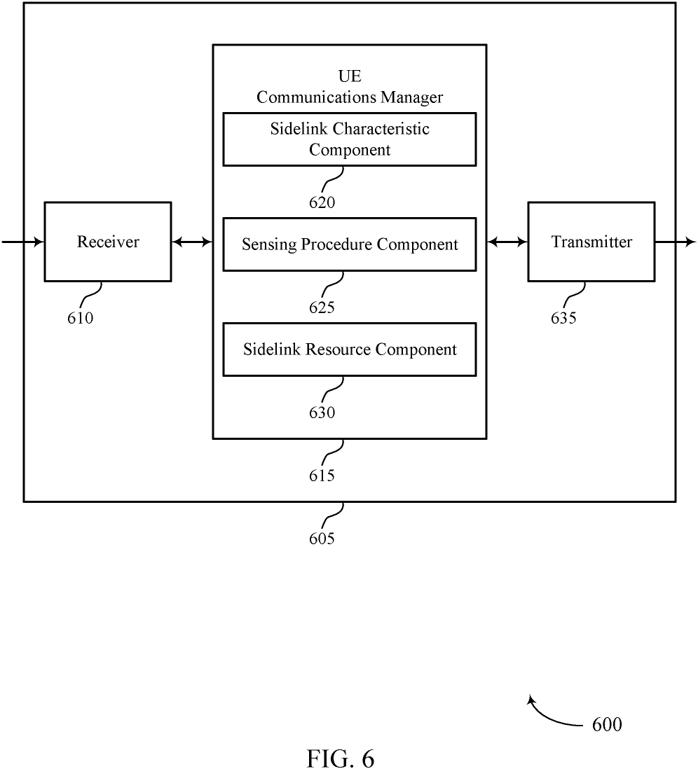

FIG. 6 shows a block diagram 600 of a device 605 that supports techniques for adapting resource sensing in sidelink communications system in accordance with various aspects of the present disclosure. The device 605 may be an example of aspects of a device 505, or a UE 115 as described herein. The device 605 may include a receiver 610, a UE communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to techniques for adapting resource sensing in sidelink communications system). Information may be passed on to other components of the device 605. The receiver 610 may be an example of aspects of the transceiver 820 described with reference to FIG. 8. The receiver 610 may utilize a single antenna or a set of antennas.

The UE communications manager 615 may be an example of aspects of the UE communications manager 515 as described herein. The UE communications manager 615 may include a sidelink characteristic component 620, a sensing procedure component 625, and a sidelink resource component 630. The UE communications manager 615 may be an example of aspects of the UE communications manager 810 described herein.

The sidelink characteristic component 620 may determine a resource usage level in the wireless communications system or a transmission property associated with the sidelink communication at the UE, or a combination thereof. The sensing procedure component 625 may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The sidelink resource component 630 may identify a set of resources used for the sidelink communication at the UE based on the adjusted sensing mode or the adjusted sensing parameter, or a combination thereof and perform the sidelink communication based on the sensing mode or the sensing parameter, or a combination thereof.

The transmitter 635 may transmit signals generated by other components of the device 605. In some examples, the transmitter 635 may be collocated with a receiver 610 in a transceiver component. For example, the transmitter 635 may be an example of aspects of the transceiver 820 described with reference to FIG. 8. The transmitter 635 may utilize a single antenna or a set of antennas.

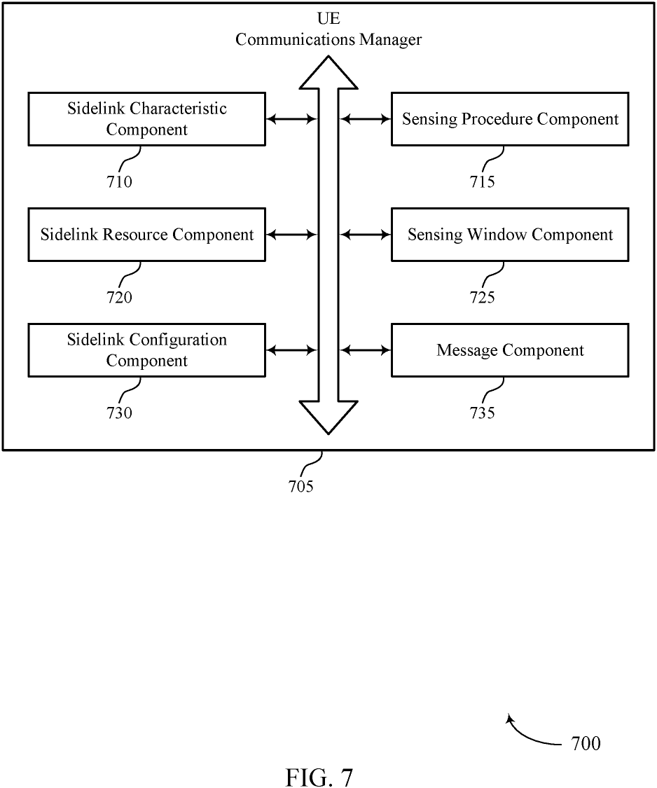

FIG. 7 shows a block diagram 700 of a UE communications manager 705 that supports techniques for adapting resource sensing in sidelink communications system in accordance with various aspects of the present disclosure. The UE communications manager 705 may be an example of aspects of a UE communications manager 515, a UE communications manager 615, or a UE communications manager 810 described herein. The UE communications manager 705 may include a sidelink characteristic component 710, a sensing procedure component 715, a sidelink resource component 720, a sensing window component 725, a sidelink configuration component 730, and a message component 735. Each of these components may communicate, directly or indirectly, with one another (e.g., via one or more buses).

The sidelink characteristic component 710 may determine a resource usage level in the wireless communications system or a transmission property associated with the sidelink communication at the UE, or a combination thereof. In some examples, the sidelink characteristic component 710 may determine a channel busy ratio associated with a sidelink channel in the wireless communications system. In some examples, the sidelink characteristic component 710 may determine a channel occupancy ratio associated with a sidelink channel in the wireless communications system.

The sidelink characteristic component 710 may determine a modulation and coding scheme associated with the sidelink communication at the UE. In some examples, the sidelink characteristic component 710 may determine a transport block size associated with the sidelink communication at the UE. The sidelink characteristic component 710 may determine a size of a frequency resource allocation associated with the sidelink communication at the UE. In some examples, the sidelink characteristic component 710 may determine a rate of the sidelink communication at the UE. In some examples, the sidelink characteristic component 710 may determine a transmission priority of the sidelink communication at the UE.

The sensing procedure component 715 may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. In some examples, the sensing procedure component 715 may switch to the full sensing mode from the partial sensing mode or the random resource-selection sensing mode based on the determined resource usage level in the wireless communications system satisfying a threshold, where identifying the set of resources used for the sidelink communication is based on switching to the full sensing mode. In some examples, the sensing procedure component 715 may switch to the random resource-selection sensing mode from the full sensing mode or the partial sensing mode based on the determined resource usage level in the wireless communications system satisfying a threshold, where identifying the set of resources used for the sidelink communication is based on switching to the random resource-selection sensing mode.

The sensing procedure component 715 may switch to the full sensing mode from the partial sensing mode or the random resource-selection sensing mode based on a frequency resource allocation satisfying a threshold, where identifying the set of resources used for the sidelink communication is based on switching to the full sensing mode. In some examples, the sensing procedure component 715 may switch to the partial sensing mode or the random resource-selection sensing mode from the full sensing mode based on a frequency resource allocation satisfying a threshold, where identifying the set of resources used for the sidelink communication is based on switching to the random resource-selection sensing mode. In some cases, the sensing mode includes a full sensing mode, a partial sensing mode, or a random resource-selection sensing mode.

The sidelink resource component 720 may identify a set of resources used for the sidelink communication at the UE based on the adjusted sensing mode or the adjusted sensing parameter, or a combination thereof. In some examples, the sidelink resource component 720 may perform the sidelink communication based on the sensing mode or the sensing parameter, or a combination thereof. In some examples, the sidelink resource component 720 may adjust a number of slots to use for identifying the set of resources, the number of slots associated with a sensing window, based on the determined resource usage level in the wireless communications system or the determined transmission property associated with the sidelink communication at the UE, or a combination thereof, where identifying the set of resources used for the sidelink communication is based on the adjusted number of slots to use for identifying the set of resources.

The sensing window component 725 may adjust a size of a sensing window based on the determined resource usage level in the wireless communications system or the determined transmission property associated with the sidelink communication at the UE, or a combination thereof, where identifying the set of resources used for the sidelink communication is based on the adjusted size of the sensing window.

The sidelink configuration component 730 may identify a sensing configuration per resource pool. In some examples, the sidelink configuration component 730 may determine an association between the sensing mode, the sensing parameter, the determined resource usage level in the wireless communications system, or the determined transmission property associated with the sidelink communication at the UE, or a combination thereof, based on the sensing configuration per resource pool. In some examples, the sidelink configuration component 730 may determine to adjust the sensing mode of the sensing procedure or the sensing parameter of the sensing procedure, or a combination thereof, based on the determined association.

The message component 735 may receive, from another UE, a message including an indication of the sensing configuration on one or more configured resources. In some examples, the message component 735 may receive, from another UE, a message including an indication of the sensing configuration on one or more periodic reserved resources.

FIG. 8 shows a diagram of a system 800 including a device 805 that supports techniques for adapting resource sensing in sidelink communications system in accordance with various aspects of the present disclosure. The device 805 may be an example of or include the components of device 505, device 605, or a UE 115 as described herein. The device 805 may include components for bi-directional voice and data communications including components for transmitting and receiving communications, including a UE communications manager 810, an I/O controller 815, a transceiver 820, an antenna 825, memory 830, and a processor 840. These components may be in electronic communication via one or more buses (e.g., bus 845).

The UE communications manager 810 may determine a resource usage level in the wireless communications system or a transmission property associated with the sidelink communication at the UE, or a combination thereof. The UE communications manager 810 may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The UE communications manager 810 may identify a set of resources used for the sidelink communication at the UE based on the adjusted sensing mode or the adjusted sensing parameter, or a combination thereof. The UE communications manager 810 may perform the sidelink communication based on the sensing mode or the sensing parameter, or a combination thereof.

The UE communications manager 810 may enable the device 805 to provide enhanced sensing based on adapting a sensing procedure. In some implementations, the UE communications manager 810 may enable the device 805 to determine a resource usage level of a wireless communications system, for example, based on a channel busy ratio or a channel occupancy ration. Additionally or alternatively, the UE communications manager 810 may enable the device 805 to determine a transmission property for sidelink communications by the device 805. Based on implementing these determinations, one or more processors of the device 805 (e.g., processor(s) controlling or incorporated with the UE communications manager 810) may adjust a sensing mode or a sensing parameter of the sensing procedure, and thereby reduce power consumption and promote high reliability sensing operations, among other benefits.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas. In some cases, the device 805 may include a single antenna 825. However, in some cases, the device 805 may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor 840 to perform various functions described herein. In some cases, the memory 830 may contain, among other things, a basic input/output system (BIOS) which may control basic hardware or software operation such as the interaction with peripheral components or devices.

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for adapting resource sensing in sidelink communications system).

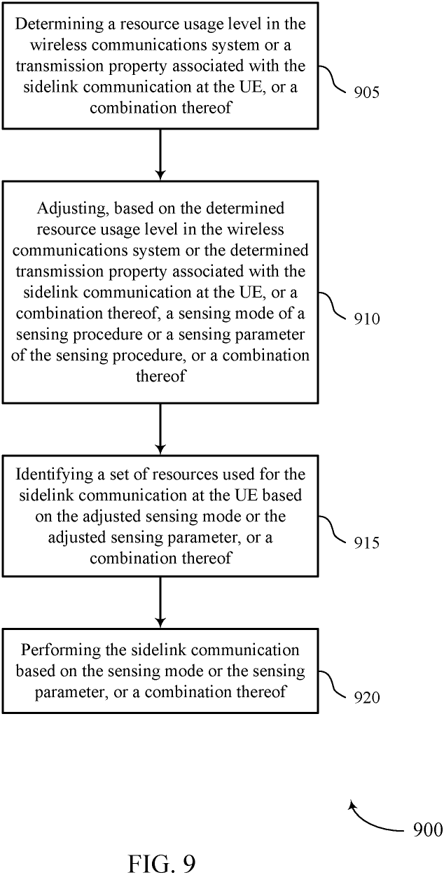

FIG. 9 shows a flowchart illustrating a method 900 that supports techniques for adapting resource sensing in sidelink communications system in accordance with various aspects of the present disclosure. The operations of method 900 may be implemented by a UE 115 or its components as described herein. For example, the operations of method 900 may be performed by a UE communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 905, the UE may determine a resource usage level in the wireless communications system or a transmission property associated with the sidelink communication at the UE, or a combination thereof. The operations of 905 may be performed according to the methods described herein. In some examples, aspects of the operations of 905 may be performed by a sidelink characteristic component as described with reference to FIGS. 5 through 8.

At 910, the UE may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The operations of 910 may be performed according to the methods described herein. In some examples, aspects of the operations of 910 may be performed by a sensing procedure component as described with reference to FIGS. 5 through 8.

At 915, the UE may identify a set of resources used for the sidelink communication at the UE based on the adjusted sensing mode or the adjusted sensing parameter, or a combination thereof. The operations of 915 may be performed according to the methods described herein. In some examples, aspects of the operations of 915 may be performed by a sidelink resource component as described with reference to FIGS. 5 through 8.

At 920, the UE may perform the sidelink communication based on the sensing mode or the sensing parameter, or a combination thereof. The operations of 920 may be performed according to the methods described herein. In some examples, aspects of the operations of 920 may be performed by a sidelink resource component as described with reference to FIGS. 5 through 8.

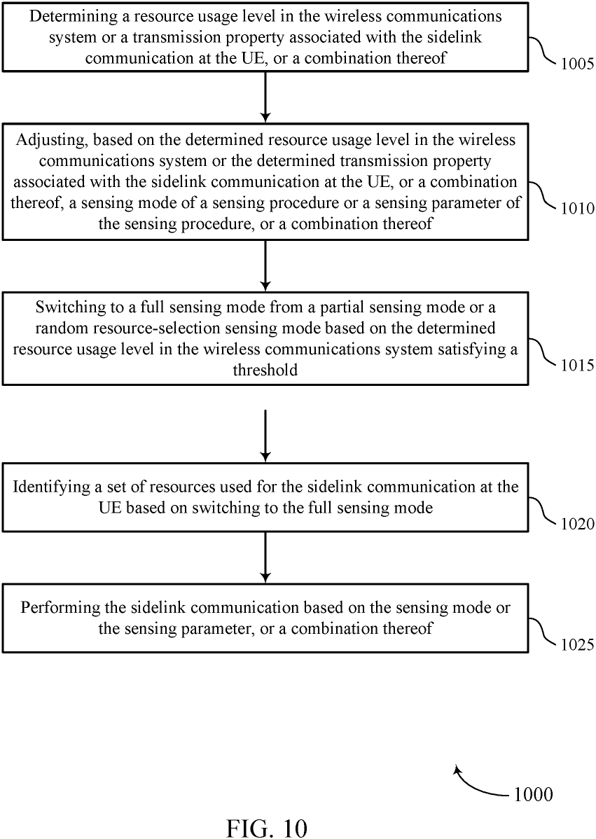

FIG. 10 shows a flowchart illustrating a method 1000 that supports techniques for adapting resource sensing in sidelink communications system in accordance with various aspects of the present disclosure. The operations of method 1000 may be implemented by a UE 115 or its components as described herein. For example, the operations of method 1000 may be performed by a communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1005, the UE may determine a resource usage level in the wireless communications system or a transmission property associated with the sidelink communication at the UE, or a combination thereof. The operations of 1005 may be performed according to the methods described herein. In some examples, aspects of the operations of 1005 may be performed by a sidelink characteristic component as described with reference to FIGS. 5 through 8.

At 1010, the UE may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The operations of 1010 may be performed according to the methods described herein. In some examples, aspects of the operations of 1010 may be performed by a sensing procedure component as described with reference to FIGS. 5 through 8.

At 1015, the UE may switch to the full sensing mode from the partial sensing mode or the random resource-selection sensing mode based on the determined resource usage level in the wireless communications system satisfying a threshold, where identifying the set of resources used for the sidelink communication is based on switching to the full sensing mode. The operations of 1015 may be performed according to the methods described herein. In some examples, aspects of the operations of 1015 may be performed by a sensing procedure component as described with reference to FIGS. 5 through 8.

At 1020, the UE may identify a set of resources used for the sidelink communication at the UE based on switching to the full sensing mode. The operations of 1020 may be performed according to the methods described herein. In some examples, aspects of the operations of 1020 may be performed by a sidelink resource component as described with reference to FIGS. 5 through 8.

At 1025, the UE may perform the sidelink communication based on the sensing mode or the sensing parameter, or a combination thereof. The operations of 1025 may be performed according to the methods described herein. In some examples, aspects of the operations of 1025 may be performed by a sidelink resource component as described with reference to FIGS. 5 through 8.

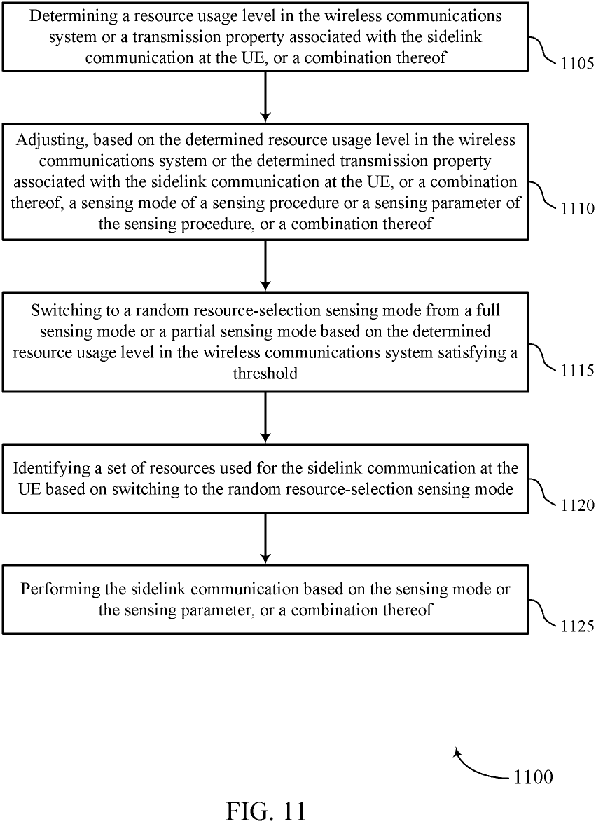

FIG. 11 shows a flowchart illustrating a method 1100 that supports techniques for adapting resource sensing in sidelink communications system in accordance with various aspects of the present disclosure. The operations of method 1100 may be implemented by a UE 115 or its components as described herein. For example, the operations of method 1100 may be performed by a UE communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1105, the UE may determine a resource usage level in the wireless communications system or a transmission property associated with the sidelink communication at the UE, or a combination thereof. The operations of 1105 may be performed according to the methods described herein. In some examples, aspects of the operations of 1105 may be performed by a sidelink characteristic component as described with reference to FIGS. 5 through 8.

At 1110, the UE may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The operations of 1110 may be performed according to the methods described herein. In some examples, aspects of the operations of 1110 may be performed by a sensing procedure component as described with reference to FIGS. 5 through 8.

At 1115, the UE may switch to a random resource-selection sensing mode from a full sensing mode or a partial sensing mode based on the determined resource usage level in the wireless communications system satisfying a threshold. The operations of 1115 may be performed according to the methods described herein. In some examples, aspects of the operations of 1115 may be performed by a sensing procedure component as described with reference to FIGS. 5 through 8.

At 1120, the UE may identify a set of resources used for the sidelink communication at the UE based on switching to the random resource-selection sensing mode. The operations of 1120 may be performed according to the methods described herein. In some examples, aspects of the operations of 1120 may be performed by a sidelink resource component as described with reference to FIGS. 5 through 8.

At 1125, the UE may perform the sidelink communication based on the sensing mode or the sensing parameter, or a combination thereof. The operations of 1125 may be performed according to the methods described herein. In some examples, aspects of the operations of 1125 may be performed by a sidelink resource component as described with reference to FIGS. 5 through 8.

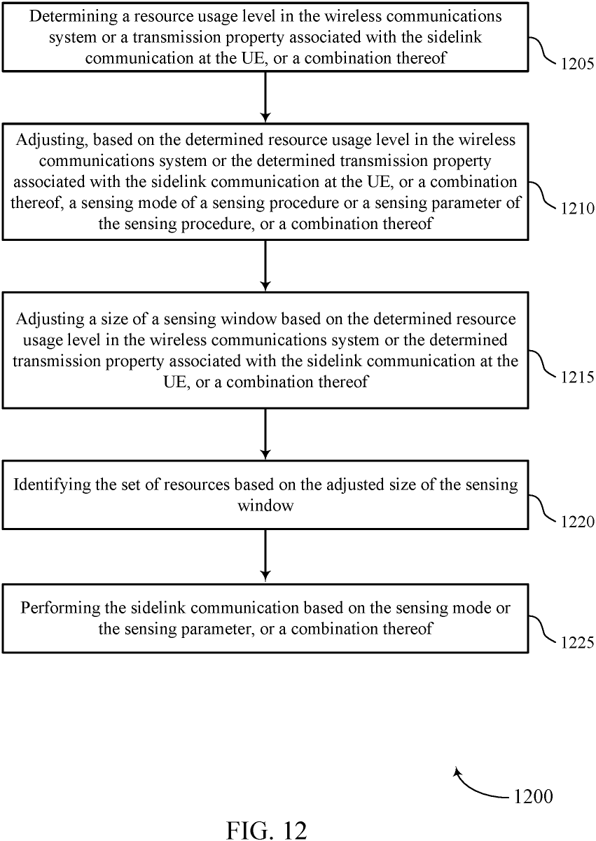

FIG. 12 shows a flowchart illustrating a method 1200 that supports techniques for adapting resource sensing in sidelink communications system in accordance with various aspects of the present disclosure. The operations of method 1200 may be implemented by a UE 115 or its components as described herein. For example, the operations of method 1200 may be performed by a UE communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1205, the UE may determine a resource usage level in the wireless communications system or a transmission property associated with the sidelink communication at the UE, or a combination thereof. The operations of 1205 may be performed according to the methods described herein. In some examples, aspects of the operations of 1205 may be performed by a sidelink characteristic component as described with reference to FIGS. 5 through 8.

At 1210, the UE may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The operations of 1210 may be performed according to the methods described herein. In some examples, aspects of the operations of 1210 may be performed by a sensing procedure component as described with reference to FIGS. 5 through 8.

At 1215, the UE may adjust a size of a sensing window based on the determined resource usage level in the wireless communications system or the determined transmission property associated with the sidelink communication at the UE, or a combination thereof. The operations of 1215 may be performed according to the methods described herein. In some examples, aspects of the operations of 1215 may be performed by a sensing window component as described with reference to FIGS. 5 through 8.

At 1220, the UE may identify the set of resources based on the adjusted size of the sensing window. The operations of 1220 may be performed according to the methods described herein. In some examples, aspects of the operations of 1220 may be performed by a sensing window component as described with reference to FIGS. 5 through 8.

At 1225, the UE may perform the sidelink communication based on the sensing mode or the sensing parameter, or a combination thereof. The operations of 1225 may be performed according to the methods described herein. In some examples, aspects of the operations of 1225 may be performed by a sidelink resource component as described with reference to FIGS. 5 through 8.

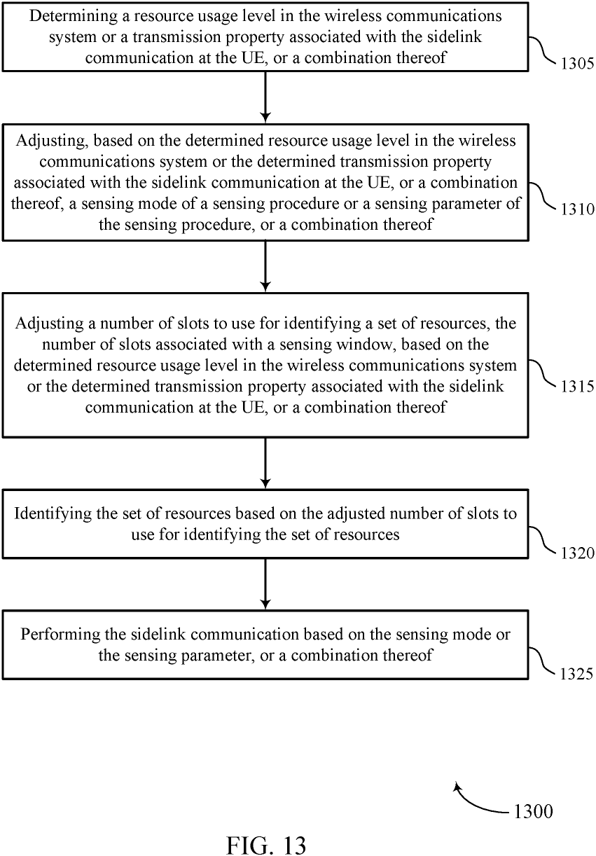

FIG. 13 shows a flowchart illustrating a method 1300 that supports techniques for adapting resource sensing in sidelink communications system in accordance with various aspects of the present disclosure. The operations of method 1300 may be implemented by a UE 115 or its components as described herein. For example, the operations of method 1300 may be performed by a UE communications manager as described with reference to FIGS. 5 through 8. In some examples, a UE may execute a set of instructions to control the functional elements of the UE to perform the functions described below. Additionally or alternatively, a UE may perform aspects of the functions described below using special-purpose hardware.

At 1305, the UE may determine a resource usage level in the wireless communications system or a transmission property associated with the sidelink communication at the UE, or a combination thereof. The operations of 1305 may be performed according to the methods described herein. In some examples, aspects of the operations of 1305 may be performed by a sidelink characteristic component as described with reference to FIGS. 5 through 8.

At 1310, the UE may adjust, based on the determined resource usage level in the wireless communications system or the determined transmission property associated with the sidelink communication at the UE, or a combination thereof, a sensing mode of a sensing procedure or a sensing parameter of the sensing procedure, or a combination thereof. The operations of 1310 may be performed according to the methods described herein. In some examples, aspects of the operations of 1310 may be performed by a sensing procedure component as described with reference to FIGS. 5 through 8.

At 1315, the UE may adjust a number of slots to use for identifying a set of resources, the number of slots associated with a sensing window, based on the determined resource usage level in the wireless communications system or the determined transmission property associated with the sidelink communication at the UE, or a combination thereof. The operations of 1315 may be performed according to the methods described herein. In some examples, aspects of the operations of 1315 may be performed by a sidelink resource component as described with reference to FIGS. 5 through 8.

At 1320, the UE may identify the set of resources based on the adjusted number of slots to use for identifying the set of resources. The operations of 1320 may be performed according to the methods described herein. In some examples, aspects of the operations of 1320 may be performed by a sidelink resource component as described with reference to FIGS. 5 through 8.

At 1325, the UE may perform the sidelink communication based on the sensing mode or the sensing parameter, or a combination thereof. The operations of 1325 may be performed according to the methods described herein. In some examples, aspects of the operations of 1325 may be performed by a sidelink resource component as described with reference to FIGS. 5 through 8.

The following provides an overview of aspects of the present disclosure:

Aspect 1: A method for sidelink communication at a UE in a wireless communications system, comprising: determining a resource usage level in the wireless communications system or a transmission property associated with the sidelink communication at the UE, or a combination thereof; adjusting, based at least in part on the determined resource usage level in the wireless communications system or the determined transmission property associated with the sidelink communication at the UE, or a combination thereof, a sensing mode of a sensing procedure or a sensing parameter of the sensing procedure, or a combination thereof; identifying a set of resources used for the sidelink communication at the UE based at least in part on the adjusted sensing mode or the adjusted sensing parameter, or a combination thereof; and performing the sidelink communication based at least in part on the sensing mode or the sensing parameter, or a combination thereof.

Aspect 2: The method of aspect 1, wherein the sensing mode includes a full sensing mode, a partial sensing mode, or a random resource-selection sensing mode.

Aspect 3: The method of aspect 2, wherein adjusting the sensing mode of the sensing procedure comprises: switching to the full sensing mode from the partial sensing mode or the random resource-selection sensing mode based at least in part on the determined resource usage level in the wireless communications system satisfying a threshold, wherein identifying the set of resources used for the sidelink communication is based at least in part on switching to the full sensing mode.

Aspect 4: The method of aspect 2, wherein adjusting the sensing mode of the sensing procedure comprises: switching to the random resource-selection sensing mode from the full sensing mode or the partial sensing mode based at least in part on the determined resource usage level in the wireless communications system satisfying a threshold, wherein identifying the set of resources used for the sidelink communication is based at least in part on switching to the random resource-selection sensing mode.

Aspect 5: The method of aspect 2, wherein adjusting the sensing mode of the sensing procedure comprises: switching to the full sensing mode from the partial sensing mode or the random resource-selection sensing mode based at least in part on a frequency resource allocation satisfying a threshold, wherein identifying the set of resources used for the sidelink communication is based at least in part on switching to the full sensing mode.

Aspect 6: The method of aspect 2, wherein adjusting the sensing mode of the sensing procedure comprises: switching to the partial sensing mode or the random resource-selection sensing mode from the full sensing mode based at least in part on a frequency resource allocation satisfying a threshold, wherein identifying the set of resources used for the sidelink communication is based at least in part on switching to the random resource-selection sensing mode.

Aspect 7: The method of any of aspects 1 through 6, wherein adjusting the sensing parameter of the sensing procedure comprises: adjusting a size of a sensing window based at least in part on the determined resource usage level in the wireless communications system or the determined transmission property associated with the sidelink communication at the UE, or a combination thereof, wherein identifying the set of resources used for the sidelink communication comprises: identifying the set of resources based at least in part on the adjusted size of the sensing window.

Aspect 8: The method of any of aspects 1 through 7, wherein adjusting the sensing parameter of the sensing procedure comprises: adjusting a number of slots to use for identifying the set of resources, the number of slots associated with a sensing window, based at least in part on the determined resource usage level in the wireless communications system or the determined transmission property associated with the sidelink communication at the UE, or a combination thereof, wherein identifying the set of resources used for the sidelink communication comprises: identifying the set of resources based at least in part on the adjusted number of slots to use for identifying the set of resources.

Aspect 9: The method of any of aspects 1 through 8, wherein determining the resource usage level comprises: determining a channel busy ratio associated with a sidelink channel in the wireless communications system.

Aspect 10: The method of any of aspects 1 through 9, wherein determining the resource usage level comprises: determining a channel occupancy ratio associated with a sidelink channel in the wireless communications system.

Aspect 11: The method of any of aspects 1 through 10, wherein determining the transmission property comprises: determining a modulation and coding scheme associated with the sidelink communication at the UE.

Aspect 12: The method of any of aspects 1 through 11, wherein determining the transmission property comprises: determining a transport block size associated with the sidelink communication at the UE.

Aspect 13: The method of any of aspects 1 through 12, wherein determining the transmission property comprises: determining a size of a frequency resource allocation associated with the sidelink communication at the UE.

Aspect 14: The method of any of aspects 1 through 13, wherein determining the transmission property comprises: determining a rate of the sidelink communication at the UE.

Aspect 15: The method of any of aspects 1 through 14, wherein determining the transmission property comprises: determining a transmission priority of the sidelink communication at the UE.

Aspect 16: The method of any of aspects 1 through 15, further comprising: identifying a sensing configuration per resource pool; determining an association between the sensing mode, the sensing parameter, the determined resource usage level in the wireless communications system, or the determined transmission property associated with the sidelink communication at the UE, or a combination thereof, based at least in part on the sensing configuration per resource pool; and determining to adjust the sensing mode of the sensing procedure or the sensing parameter of the sensing procedure, or a combination thereof, based at least in part on the determined association.

Aspect 17: The method of aspect 16, further comprising: receiving, from another UE, a message including an indication of the sensing configuration on one or more configured resources.

Aspect 18: The method of any of aspects 16 through 17, further comprising: receiving, from another UE, a message including an indication of the sensing configuration on one or more periodic reserved resources.

Aspect 19: An apparatus for sidelink communication at a UE in a wireless communications system, comprising a processor; memory coupled with the processor; and instructions stored in the memory and executable by the processor to cause the apparatus to perform a method of any of aspects 1 through 18.

Aspect 20: An apparatus for sidelink communication at a UE in a wireless communications system, comprising at least one means for performing a method of any of aspects 1 through 18.

Aspect 21: A non-transitory computer-readable medium storing code for sidelink communication at a UE in a wireless communications system, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope with the principles and novel features disclosed herein.

What is claimed is:

1. A method for sidelink communication at a user equipment (UE) in a wireless communications system, comprising:
determining a resource usage level in the wireless communications system or a transmission property associated with the sidelink communication at the UE, or a combination thereof;
adjusting, based at least in part on the determined resource usage level in the wireless communications system or the determined transmission property associated with the sidelink communication at the UE, or a combination thereof, a sensing mode of a sensing procedure or a sensing parameter of the sensing procedure, or a combination thereof;
identifying a set of resources used for the sidelink communication at the UE based at least in part on the adjusted sensing mode or the adjusted sensing parameter, or a combination thereof; and
performing the sidelink communication based at least in part on the sensing mode or the sensing parameter, or a combination thereof.

2. The method of claim 1, wherein the sensing mode includes a full sensing mode, a partial sensing mode, or a random resource-selection sensing mode.

3. The method of claim 2, wherein adjusting the sensing mode of the sensing procedure comprises:
switching to the full sensing mode from the partial sensing mode or the random resource-selection sensing mode based at least in part on the determined resource usage level in the wireless communications system satisfying a threshold, wherein identifying the set of resources used for the sidelink communication is based at least in part on switching to the full sensing mode.

4. The method of claim 2, wherein adjusting the sensing mode of the sensing procedure comprises:
switching to the random resource-selection sensing mode from the full sensing mode or the partial sensing mode based at least in part on the determined resource usage level in the wireless communications system satisfying a threshold, wherein identifying the set of resources used for the sidelink communication is based at least in part on switching to the random resource-selection sensing mode.

5. The method of claim 2, wherein adjusting the sensing mode of the sensing procedure comprises:
switching to the full sensing mode from the partial sensing mode or the random resource-selection sensing mode based at least in part on a frequency resource allocation satisfying a threshold, wherein identifying the set of resources used for the sidelink communication is based at least in part on switching to the full sensing mode.

6. The method of claim 2, wherein adjusting the sensing mode of the sensing procedure comprises:
switching to the partial sensing mode or the random resource-selection sensing mode from the full sensing mode based at least in part on a frequency resource allocation satisfying a threshold, wherein identifying the set of resources used for the sidelink communication is based at least in part on switching to the random resource-selection sensing mode.

7. The method of claim 1, wherein adjusting the sensing parameter of the sensing procedure comprises:
adjusting a size of a sensing window based at least in part on the determined resource usage level in the wireless communications system or the determined transmission property associated with the sidelink communication at the UE, or a combination thereof, wherein identifying the set of resources used for the sidelink communication comprises:
identifying the set of resources based at least in part on the adjusted size of the sensing window.

8. The method of claim 1, wherein adjusting the sensing parameter of the sensing procedure comprises:
adjusting a number of slots to use for identifying the set of resources, the number of slots associated with a sensing window, based at least in part on the determined resource usage level in the wireless communications system or the determined transmission property associated with the sidelink communication at the UE, or a combination thereof, wherein identifying the set of resources used for the sidelink communication comprises:
identifying the set of resources based at least in part on the adjusted number of slots to use for identifying the set of resources.

9. The method of claim 1, wherein determining the resource usage level comprises:
determining a channel busy ratio associated with a sidelink channel in the wireless communications system.

10. The method of claim 1, wherein determining the resource usage level comprises:
determining a channel occupancy ratio associated with a sidelink channel in the wireless communications system.

11. The method of claim 1, wherein determining the transmission property comprises:
determining a modulation and coding scheme associated with the sidelink communication at the UE.

12. The method of claim 1, wherein determining the transmission property comprises:
determining a transport block size associated with the sidelink communication at the UE.

13. The method of claim 1, wherein determining the transmission property comprises:
determining a size of a frequency resource allocation associated with the sidelink communication at the UE.

14. The method of claim 1, wherein determining the transmission property comprises:
determining a rate of the sidelink communication at the UE.

15. The method of claim 1, wherein determining the transmission property comprises:
determining a transmission priority of the sidelink communication at the UE.

16. The method of claim 1, further comprising:
identifying a sensing configuration per resource pool;
determining an association between the sensing mode, the sensing parameter, the determined resource usage level in the wireless communications system, or the determined transmission property associated with the sidelink communication at the UE, or a combination thereof, based at least in part on the sensing configuration per resource pool; and
determining to adjust the sensing mode of the sensing procedure or the sensing parameter of the sensing procedure, or a combination thereof, based at least in part on the determined association.

17. The method of claim 16, further comprising:
receiving, from another UE, a message including an indication of the sensing configuration on one or more configured resources.

18. The method of claim 16, further comprising:
receiving, from another UE, a message including an indication of the sensing configuration on one or more periodic reserved resources.

19. An apparatus for sidelink communication in a wireless communications system, comprising:
a processor,
memory coupled with the processor; and
instructions stored in the memory and executable by the processor to cause the apparatus to:
determine a resource usage level in the wireless communications system or a transmission property associated with the sidelink communication at the apparatus, or a combination thereof;
adjust, based at least in part on the determined resource usage level in the wireless communications system or the determined transmission property associated with the sidelink communication at the apparatus, or a combination thereof, a sensing mode of a sensing procedure or a sensing parameter of the sensing procedure, or a combination thereof;
identify a set of resources used for the sidelink communication at the apparatus based at least in part on the adjusted sensing mode or the adjusted sensing parameter, or a combination thereof; and
perform the sidelink communication based at least in part on the sensing mode or the sensing parameter, or a combination thereof.

20. The apparatus of claim 19, wherein the sensing mode includes a full sensing mode, a partial sensing mode, or a random resource-selection sensing mode.

21. The apparatus of claim 20, wherein the instructions to adjust the sensing mode of the sensing procedure are executable by the processor to cause the apparatus to:
switch to the full sensing mode from the partial sensing mode or the random resource-selection sensing mode based at least in part on the determined resource usage level in the wireless communications system satisfying a threshold, wherein the instructions to identify the set of resources used for the sidelink communication are further executable by the processor based at least in part on switching to the full sensing mode.

22. The apparatus of claim 20, wherein the instructions to adjust the sensing mode of the sensing procedure are executable by the processor to cause the apparatus to:
switch to the random resource-selection sensing mode from the full sensing mode or the partial sensing mode based at least in part on the determined resource usage level in the wireless communications system satisfying a threshold, wherein the instructions to identify the set of resources used for the sidelink communication are further executable by the processor based at least in part on switching to the random resource-selection sensing mode.

23. The apparatus of claim 20, wherein the instructions to adjust the sensing mode of the sensing procedure are executable by the processor to cause the apparatus to:
switch to the full sensing mode from the partial sensing mode or the random resource-selection sensing mode based at least in part on a frequency resource allocation satisfying a threshold, wherein the instructions to identify the set of resources used for the sidelink communication are further executable by the processor based at least in part on switching to the full sensing mode.

24. The apparatus of claim 20, wherein the instructions to adjust the sensing mode of the sensing procedure are executable by the processor to cause the apparatus to:
switch to the partial sensing mode or the random resource-selection sensing mode from the full sensing mode based at least in part on a frequency resource allocation satisfying a threshold, wherein the instructions to identify the set of resources used for the sidelink communication are further executable by the processor based at least in part on switching to the random resource-selection sensing mode.

25. The apparatus of claim 19, wherein the instructions to adjust the sensing parameter of the sensing procedure are executable by the processor to cause the apparatus to:
adjust a size of a sensing window based at least in part on the determined resource usage level in the wireless communications system or the determined transmission property associated with the sidelink communication at the apparatus, or a combination thereof, wherein the instructions to identify the set of resources used for the sidelink communication are further executable by the processor to cause the apparatus to:
identify the set of resources based at least in part on the adjusted size of the sensing window.

26. The apparatus of claim 19, wherein the instructions to adjust the sensing parameter of the sensing procedure are executable by the processor to cause the apparatus to:
adjust a number of slots to use for identifying the set of resources, the number of slots associated with a sensing window, based at least in part on the determined resource usage level in the wireless communications system or the determined transmission property associated with the sidelink communication at the apparatus, or a combination thereof, wherein the instructions to identify the set of resources used for the sidelink communication are further executable by the processor to cause the apparatus to:
identify the set of resources based at least in part on the adjusted number of slots to use for identifying the set of resources.

27. The apparatus of claim 19, wherein the instructions are further executable by the processor to cause the apparatus to:
identify a sensing configuration per resource pool;
determine an association between the sensing mode, the sensing parameter, the determined resource usage level in the wireless communications system, or the determined transmission property associated with the sidelink communication at the apparatus, or a combination thereof, based at least in part on the sensing configuration per resource pool; and
determine to adjust the sensing mode of the sensing procedure or the sensing parameter of the sensing procedure, or a combination thereof, based at least in part on the determined association.

28. The apparatus of claim 27, wherein the instructions are further executable by the processor to cause the apparatus to:
receive, from another apparatus, a message including an indication of the sensing configuration on one or more configured resources.

29. An apparatus for sidelink communication in a wireless communications system, comprising:
means for determining a resource usage level in the wireless communications system or a transmission property associated with the sidelink communication at the apparatus, or a combination thereof;
means for adjusting, based at least in part on the determined resource usage level in the wireless communications system or the determined transmission property associated with the sidelink communication at the apparatus, or a combination thereof, a sensing mode of a sensing procedure or a sensing parameter of the sensing procedure, or a combination thereof;
means for identifying a set of resources used for the sidelink communication at the apparatus based at least in part on the adjusted sensing mode or the adjusted sensing parameter, or a combination thereof; and
means for performing the sidelink communication based at least in part on the sensing mode or the sensing parameter, or a combination thereof.

30. A non-transitory computer-readable medium storing code for sidelink communication at a user equipment (UE) in a wireless communications system, the code comprising instructions executable by a processor to:
determine a resource usage level in the wireless communications system or a transmission property associated with the sidelink communication at the UE, or a combination thereof;
adjust, based at least in part on the determined resource usage level in the wireless communications system or the determined transmission property associated with the sidelink communication at the UE, or a combination thereof, a sensing mode of a sensing procedure or a sensing parameter of the sensing procedure, or a combination thereof;
identify a set of resources used for the sidelink communication at the UE based at least in part on the adjusted sensing mode or the adjusted sensing parameter, or a combination thereof; and
perform the sidelink communication based at least in part on the sensing mode or the sensing parameter, or a combination thereof.
